(19) United States
(12) Patent Application Publication
(10) Pub. No.: US 2023/0334642 A1
(43) Pub. Date: Oct. 19, 2023

(54) Vehicle Inspection Using a Mobile Application

(71) Applicant: Tractable Ltd, London (GB)

(72) Inventors: Ken CHATFIELD, London (GB); Yih Kai TEH, London (GB)

(21) Appl. No.: 18/303,115

(22) Filed: Apr. 19, 2023

Related U.S. Application Data
(60) Provisional application No. 63/363,227, filed on Apr. 19, 2022.

(51) Int. Cl. G06T 7/00; G06Q 40/08; G06V 10/776; H04N 23/60

(52) U.S. Cl. CPC G06T 7/0002; G06Q 40/08; G06V 10/776; H04N 23/64; G06T 2200/24; G06T 2207/30168

(57) ABSTRACT

A system is configured to capture images of a vehicle, perform, by one or more machine learning models, a visual inspection of the vehicle based on the images, determine, by the one or more machine learning models, inspection results based on the visual inspection and determine, by the one or more machine learning models, a confidence value for the inspection results.

### PRIORITY/INCORPORATION BY REFERENCE

This application claims priority to U.S. Provisional Application Ser. No. 63/363,227 filed on Apr. 19, 2022 and entitled “Vehicle Inspection,” the entirety of which is incorporated herein by reference.

### BACKGROUND

As mobile devices become ubiquitous, various functionalities may be implemented by mobile devices executing mobile applications. Some of these mobile applications are related to initiating insurance claims for damaged vehicles or other types of inspection of vehicles. However, since the users of the mobile devices are typically not experts in the field vehicle inspections, without proper guidance, the users may not effectively collect data for the vehicle inspections.

### SUMMARY

Some exemplary embodiments are related to a method for capturing images of a vehicle, performing, by one or more machine learning models, a visual inspection of the vehicle based on the images, determining, by the one or more machine learning models, inspection results based on the visual inspection and determining, by the one or more machine learning models, a confidence value for the inspection results.

Other exemplary embodiments are related to a method for initiating an image capture process for capturing images of a vehicle, determining information related to the image capture process, selecting one or more parameters for the image capture process based on the information and capturing the images based on the selected one or more parameters.

Still further exemplary embodiments are related to a method for collecting information related to an image capture process for capturing images of a vehicle, wherein the information is collected for multiple performances of the image capture process, analyzing the information using one or more machine learning models to determine a quality of the image capture process and modifying one or more parameters of the image capture process based on the quality of the image capture process.

### BRIEF DESCRIPTION OF THE DRAWINGS

FIG. 1 shows an exemplary user device according to various exemplary embodiments.

FIG. 2 shows an exemplary system according to various exemplary embodiments.

FIG. 3 shows a method for performing an inspection using an artificial intelligence (AI) based application to assess a state of a vehicle according to various exemplary embodiments.

FIG. 4 shows an example view of a video viewer according to various exemplary embodiments.

FIGS. 5a-d show example screen shots of an AI application on the user device 100 according to various exemplary embodiments.

### DETAILED DESCRIPTION

The exemplary embodiments may be further understood with reference to the following description and the related appended drawings, wherein like elements are provided with the same reference numerals. The exemplary embodiments are related to improving an inspection of a vehicle using an artificial intelligence (AI) system. Specifically, the exemplary embodiments are directed to improving information gathering for the AI system. In addition, the exemplary embodiments are also directed at improving the operation of the AI system by interacting with human experts to handle certain use cases.

The exemplary embodiments are described with regard to an application running on a user device. However, reference to the term “user device” is merely provided for illustrative purposes. The exemplary embodiments may be used with any electronic component that is configured with the hardware, software and/or firmware to communicate with a network and collect video of the vehicle, e.g., mobile phones, tablet computers, smartphones, etc. Therefore, the user device as described herein is used to represent any suitable electronic device.

Furthermore, throughout this description, it may be described that certain operations are performed by “one or more machine learning models.” Those skilled in the art will understand that there are many different types of machine learning models. For example, the exemplary machine learning models described herein may include visual and non-visual algorithms. Furthermore, the exemplary machine learning models may include classifiers and/or regression models. Those skilled in the art will understand that, in general, a classifier model may be used to determine a probability that a particular outcome will occur (e.g., an 80% chance that a part of a vehicle should be replaced rather than repaired). While a regression model may provide a value (e.g., repairing a part of a vehicle will require 7.5 labor hours). Other examples of machine learning models may include multitask learning models (MTL) that can perform both classification, regression and other tasks. The resulting AI system described below may include some or all of the above machine learning components or any other type of machine learning model that may be applied to determine the expected outcome of the AI system.

It should be understood that any reference to one or more machine learning models may refer to a single machine learning model or a group of machine learning models. In addition, it should also be understood that the “one or more machine learning models” described as performing different operations may be the same machine learning models or different machine learning models. As will be described in more detail below, in some exemplary embodiments, some or all of the operations may be performed by a user device. In some exemplary embodiments related to the user device (or any other type of device), a single machine learning model may perform all the operations described herein.

In the exemplary embodiments, it may be described that the AI system be performing inspections of vehicles damaged in an accident. However, it should be understood that this is only exemplary and the exemplary embodiments are not limited to this scenario. There may be other reasons for performing the inspection of the vehicle that are unrelated to accident damage and the exemplary embodiments may be used for any of these reasons.

An entity may release an application that utilizes AI to assess the state of the vehicle to provide any of a variety of different services. To provide an example, the state of the vehicle may be evaluated by the AI system to produce an estimated repair cost. In another example, the state of the vehicle may be evaluated by the AI system to appraise the vehicle. However, the exemplary embodiments are not limited to the example use cases referenced above. The exemplary techniques described herein may be used in independently from one another, in conjunction with currently implemented AI systems, in conjunction with future implementations of AI systems or independently from other AI systems.

According to some aspects, one or more machine learning models, including one or more classifiers or regression models may be executed at the user device. For example, a classifier may be used to aid the user in collecting images of the vehicle. In another example, a classifier may be used to determine different types of damage present on the vehicle or to determine the locations of the damage. In addition, the one or more classifiers may also identify the locations of parts on a vehicle. In some embodiments, this may further include using a regression model for assessing a degree or magnitude of damage, and using classifiers for identifying repair operations that may be performed to improve the state of the vehicle and identifying parts that may be replaced to improve the state of the vehicle. The user device may produce the assessment of the state of the vehicle in real-time. That is, the assessment may be executed at the user device using one or more classifiers, regression models, and/or any other appropriate type of machine learning models or AI techniques. However, it should also be understood that the exemplary embodiments are not limited to the AI application being resident on the user device. In other exemplary embodiments, the AI system (or part of the AI system) may reside on a remote server to process the video and perform the assessment of the state of the vehicle.

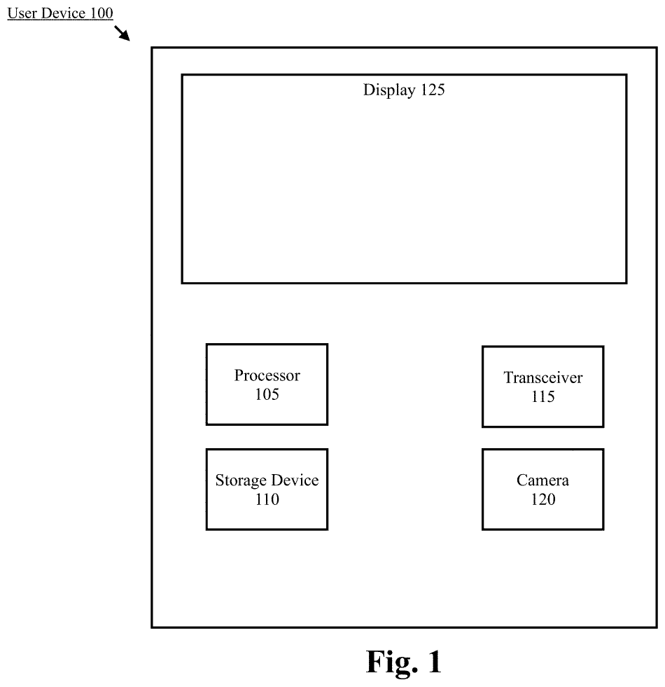

FIG. 1 shows an exemplary user device 100 according to various exemplary embodiments described herein. The user device 100 includes a processor 105 for executing the AI based application. The AI based application may be, in one embodiment, a web-based application hosted on a server and accessed over a network (e.g., a radio access network, a wireless location area network (WLAN), etc.) via a transceiver 115 or some other communications interface.

The above referenced application being executed by the processor 105 is only exemplary. The functionality associated with the application may also be represented as a separate incorporated component of the user device 100 or may be a modular component coupled to the user device 100, e.g., an integrated circuit with or without firmware. For example, the integrated circuit may include input circuitry to receive signals and processing circuitry to process the signals and other information. The AI based application may also be embodied as one application or multiple separate applications. In addition, in some user devices, the functionality described for the processor 105 is split among two or more processors such as a baseband processor and an applications processor. The exemplary embodiments may be implemented in any of these or other configurations of a user device.

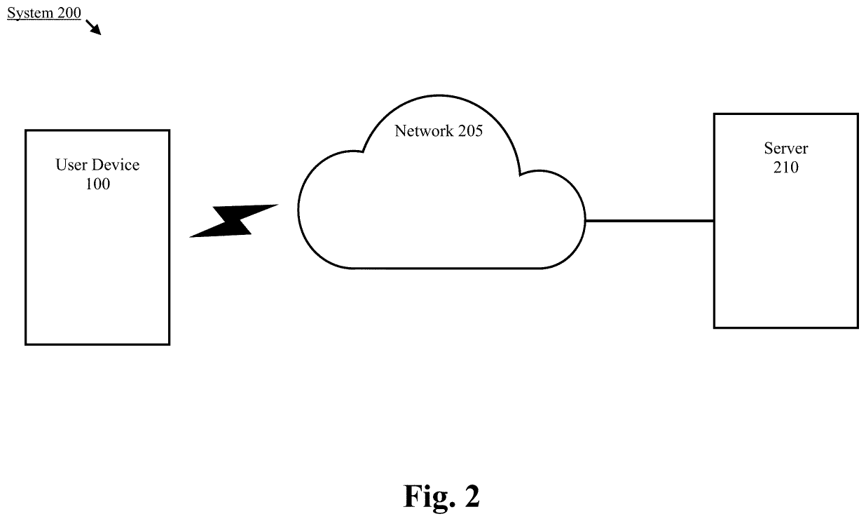

FIG. 2 shows an exemplary system 200 according to various exemplary embodiments. The system 200 includes the user device 100 in communication with a server 210 via a network 205. However, the exemplary embodiments are not limited to this type of arrangement. Reference to a single server 210 is merely provided for illustrative purposes, the exemplary embodiments may utilize any appropriate number of servers equipped with any appropriate number of processors. In addition, those skilled in the art will understand that some or all of the functionality described herein for the server 210 may be performed by one or more processors of a cloud network.

The server 210 may host the AI-based application that is executed at the user device 100. However, the user device 100 may store some or all of the application software at a storage device 110 of the user device 100. For example, in some web-based applications, a user device 100 may store all or a part of the application software locally at the user device 100. The application running on the user device 100 may perform some operations and other operations may be performed at the remote server, e.g., server 210. However, there is a tradeoff between the amount of storage that may be taken up by the application at the user device 100, a reliance on connectivity to the Internet (or any other appropriate type of data network) to perform certain tasks and the amount of time that may be required to produce a result (e.g., an assessment of the state of the vehicle). Each of these aspects should be considered to ensure an adequate user experience. As described above, in some exemplary embodiments, the user device 100 may include a single machine learning model that performs all the operations related to the data capture aspects of the inspection, e.g., guiding the user through video and/or still photography capture.

The user device 100 further includes a camera 120 for capturing video and a display 125 for displaying the application interface and/or the video with a dynamic overlay. Additional details regarding the dynamic overlay are provided below. The user device 100 may be any device that has the hardware and/or software to perform the functions described herein. In one example, the user device 100 may be a smartphone with the camera 120 located on a side (e.g., back) of the user device 100 opposite the side (e.g., front) on which the display 125 is located. The display 125 may be, for example, a touch screen for receiving user inputs in addition to displaying the images and/or other information via the web-based application.

The exemplary embodiments may allow a user to perform an inspection of a vehicle in real-time using the user device 100. As will be described in more detail below, the user may record one or more videos that are to be used to assess the state of the vehicle. The application may include one or more machine learning models for determining which parts of the vehicle have been captured in the video recorded by the user. The one or more machine learning model may be executed at the user device 100 during the recording of the video. This may allow the application to provide dynamic feedback to guide the user through the video capture process.

In the example of FIG. 2, it is shown that there may be an interaction between the user device 100 and the server 210. However, it should be understood that information from the user device 100 and/or server 210 may be distributed to other components via the network 205 or any other network. These other components may be components of the entity that operates the server 210 or may be components operated by third parties. To provide a specific example, an owner of a vehicle may perform the vehicle inspection using the user device 100. The server 210 may have pre-provisioned the user device 100 with the necessary software to perform the inspection and/or may aid the owner through the inspection (e.g., by providing specific guidance as will be described in greater detail below). The results of the vehicle inspection may then be sent to a third party such as an insurance company that may be paying for the repairs to the damaged vehicle.

The machine learning models in the AI system may be based on the use of one or more of: a non-linear hierarchical algorithm, a neural network, a convolutional neural network, a recurrent neural network, a long short-term memory network, a multi-dimensional convolutional network, a memory network, a fully convolutional network, a transformer network or a gated recurrent network.

In some embodiments, the one or more machine learning models may be stored locally at the user device 100. This may allow the application to produce quick results even when the user device 100 does not have an available connection to the Internet (or any other appropriate type of data network). In one example, only a single multitask model is stored locally at the user device 100. This single model may be trained to perform multiple different classifications and/or regressions. For example, the single model may identify all parts of the vehicle and also classify the condition, and potential repair and other operations for all the parts of the vehicle at the same time, as well as determine through regression techniques the estimated labor hours for certain repair operations. The use of a single classifier trained to perform multiple tasks may be beneficial to the user device 100 because it may take up significantly less storage space compared to multiple classifiers that are each specific to different parts of the vehicle. Thus, classifying AI described herein is sufficiently compact to run on the user device 100, and may include multi-task learning so that one classifier and/or model may perform multiple tasks.

Generally, machine learning models may be designed to progressively learn as more data is received and processed. Thus, the exemplary application described herein may periodically send its results to a centralized server so as to enable further training of the models for future assessment.

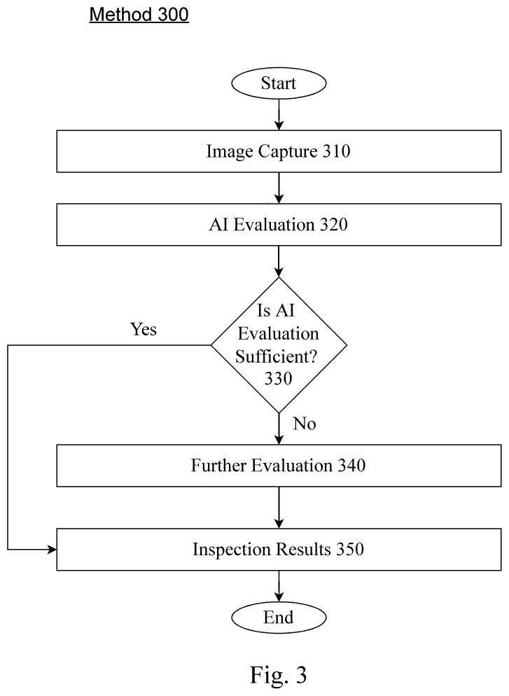

FIG. 3 shows a method 300 for performing an inspection using an AI based application to assess a state of a vehicle according to various exemplary embodiments. The method 300 is described with regard to the user device 100 of FIG. 1 and the system 200 of FIG. 2. The method 300 is intended to provide a general overview of the process of inspecting a damaged vehicle such that the inspection results may be used to repair the vehicle. For example, the method 300 may include a use case as follows: a vehicle is in an accident; the vehicle is inspected according to the operations of the method 300; inspection include an estimate for repairing the damage to the vehicle. However, it should be understood that this is only one use case and many other use cases may be encompassed by method 300.

In addition, each of the operations described for method 300 may include one or more sub-operations as will be described in more detail below. Each of the operations may also be performed by different components and/or entities. For example, the image capture 310 operations may be performed by the user device 100. However, the user device 100 may be interacting with the server 210 (or another component) during the image capture 310 operations to improve the image capture 310 operations. In addition, while the user device 100 may perform the image capture 310 operations, the user of the user device 100 may vary. For example, in various situations the user may be an owner of the vehicle, a prospective purchaser of a vehicle, an employee of a repair shop, an insurance adjuster, an insurance underwriter, etc.

Furthermore, while the operations are shown in FIG. 3 as generally linear and sequential operations, this should be understood as being exemplary. For example, some AI evaluation 320 operations may be performed while the image capture 310 operations are being performed to improve the image capture 310 operations. Again, each of these operations will be described in greater detail below.

In 310, the user device 100 may launch an application to begin the inspection process. For example, the user may select an icon for the application shown on the display 125 of the user device 100. After launch, the user may interact with the application via the user device 100. To provide a general example of a conventional interaction, the user may be presented with a graphical user interface that offers any of a variety of different interactive features. The user may select one of the features shown on the display 125 via user input entered at the display 125 of the user device 100. In response, the application may provide a new page that includes further information and/or interactive features. Accordingly, the user may move through the application by interacting with these features and/or transitioning between different application pages.

One of these features may include the image capture 310 operations where the user is prompted to collect images of the vehicle using the camera 120 of the user device 100. The feature may include a user interface (UI) or graphical user interface (GUI) to guide the user through the image capture operations. Examples of the application guiding the user through the image capture operations are provided below.

In 320, the AI system may perform the AI evaluation 320 operations using the images captured in 310. The AI evaluation 320 operations may be performed by one or more machine learning models that are run on the user device 100 and/or the server 210. As described above, in some aspects the one or more machine learning models may be used to improve the image capture operations. In other aspects, the one or more machine learning models may assess damage to the vehicle, including, but not limited to, using classifications models to determine whether a part should be repaired or replaced, using regression models to estimate of the labor hours for the repair, etc. The one or more machine learning models may enable the application to produce a full or partial initial estimate to repair the damage to the vehicle. Examples of the AI evaluation 320 are provided below.

In 330, the AI system determines whether the initial AI evaluation is sufficient. Again, this assessment may be performed by one or more of the machine learning models of the AI system operating on the user device 100 and/or the server 210. In some exemplary embodiments, the assessment may be based on a confidence value that the AI system assigns to the AI evaluation 320. For example, if the confidence value is above a threshold, the AI evaluation 320 may be considered to be sufficient. On the other hand, if the confidence value is below a threshold, the AI evaluation 320 may be considered to be insufficient and further actions (to be described below) may be taken. The confidence value may be a quantitative value (e.g., a percent (%) confidence value, a value on a scale of 1-10, etc.) or a qualitative value (e.g., a rating of high confidence, very high confidence, low confidence, etc.).

In some exemplary embodiments, the AI system may look at multiple confidence levels to determine the sufficiency of information, such as a combination of a high confidence that a specific part is present, and a low confidence as to the condition of that part resulting in the need for more information with respect to that part.

To provide a description of the confidence value by way of examples, the following scenarios may be considered. In a first example, a vehicle may have experienced a minor ding to a quarter panel in an accident. After performing the AI evaluation 320 operations using the images collected during the image capture 310, the AI system may be highly confident that the AI evaluation 320 operations produced results, e.g., inspection results that only surface repairs and re-painting of the quarter panel are required. This highly confident evaluation may be made based on the one or more machine learning models (e.g., classifiers) being trained on similar images that resulted in similar damages. Thus, if the AI system is satisfied that AI evaluation 320 operations produced results in which the AI system is highly confident, the method 300 may progress to 350 where the inspection results are provided to the interested entities, e.g., insurance company, vehicle owner, repair shop, etc.

In a second example, a vehicle may have experienced damage to various parts in an accident. After performing the AI evaluation 320 operations using the images collected during the image capture 310, the AI system may have a lower confidence that the AI evaluation 320 operations produced proper results. For example, the damage may be of a type that the one or more machine learning models have not seen, the AI system may be unsure if there is unseen internal damage, etc. Thus, if the AI system is not satisfied that AI evaluation 320 operations produced results in which the AI system is highly confident, the method 300 may progress to 340 where further evaluation operations may be performed as will be described in greater detail below.

The further evaluation 340 operations may include actions that are taken by the AI system without any further interaction or in conjunction with a human operator. For example, the AI system on its own may instruct the user to collect additional images of the vehicle without any additional human intervention. In another example, the AI system may route the images and initial AI evaluation results to a human operator such as an insurance adjuster who may then take additional actions such as instructing the user to collect additional images, reviewing the images in more detail to make a human evaluation of the damage, etc. When these further evaluation 340 operations are complete, the method 300 may progress to 350 where the inspection results are provided to the interested entities, e.g., insurance company, vehicle owner, repair shop, etc. The additional images may be requested based on, for example, a lack of images for a certain part or from a certain angle of the vehicle, or due to a low confidence value as to a classification of a part that has a high confidence value of being present. Some of these exemplary operations are described in greater detail below.

The following will provide additional details of the various operations generally described above for the method 300. Again, as was described above, it should be understood that the different operations of the method 300 may interact with the other operations in a non-linear manner to improve the entire inspection process. Thus, while the below description may be referring to further details of one of the operations, e.g., the image capture 310 operations, there may be operations from one of the other steps that are being performed within the details of other operations.

Turning to the image capture 310 operations, as was described above, the application may guide the user through the image capture 310 operations in a variety of manners. In the below description, it may be considered that the image capture operations include the user of the user device 100 taking a video of the vehicle. However, the image capture operations are not limited to video as in some exemplary embodiments, some or all of the operations may include the capturing of still images or a combination of video and still images. In other exemplary embodiments, the image capture 310 operations may include the capture of video with sound (e.g., audio information) that may also be used for the vehicle inspection. In still further exemplary embodiments, the image capture operations may include collection of other types of information such as dimensions using LIDAR (e.g., the depth of a dent) or any other type of information the user device 100 is capable of collecting from the vehicle.

Initially, or at any point within the image capture 310 operations, the application may prompt the user to capture images related to identifying information for the vehicle such as the Vehicle Identification Number (VIN), odometer, license plate, etc. The AI system may use optical character recognition (OCR) on these images to collect identifying information about the vehicle. Alternatively, the AI system may automatically recognize and capture this information when observed in the images.

In other exemplary embodiments, as the image capture 310 operations are occurring, the AI system may be processing the collected images and identifying potential damage in the video. When a location of potential damage is identified, the GUI of the application may prompt the user to collect further images for this location, such as a close up. The prompt may include a visual prompt such as a cross-hair, a bullseye, a bounding box, a large box, a flashing of the screen in the area of the location, etc. Each of these prompts may be color coded in various manners to bring attention to the location. In other exemplary embodiments, the prompt may be a combination of a visual prompt with an audio prompt (e.g., beeping, ring tone, etc.) or a haptic prompt (e.g., vibrating).

In some embodiments, the visual prompt may be geared toward the individual user of the application. For example, when the user is a non-professional such as the owner of the vehicle, the prompts may be larger or bolder to ensure the non-professional is alerted to the prompt, e.g., bigger bounding boxes. Whereas, when the user is a professional such as an insurance adjuster or repair shop technician, the prompts may be more subtle as these professional users are generally aware of locations on which to focus and the large or bold prompts may interfere with the image capture 310 operations being performed by the professional user.

This collection of further images of a location of potential damage may include prompting the user to zoom in on the location, collect higher quality still images of the location, collect images at a particular angle, etc. For example, the AI system may identify potential damage to a location or part, e.g., vehicle door. The one or more machine learning models (e.g., classifiers) of the AI system may also be trained to understand the angles or types of view that a professional appraiser would use to assess the damage for this part or location. The application may then prompt the user to collect images using the angles or types of views that would likely be helpful in assessing the damage.

In some exemplary embodiments, the application may be trained to capture additional images without further prompts to the user. For example, as described above, the AI system may identify a location of potential damage, and the AI system may automatically instruct the user device 100 to perform additional image capture operations. For example, the AI system may instruct the user device 100 to collect higher quality video for the identified location, e.g., higher resolution video, utilize a different compression algorithm, do not utilize a compression algorithm.

In another example, the AI system may instruct the user device 100 to collect still images for the identified location. In this example, the entire video may be taken at a standard video quality and high quality still images (e.g., higher resolution and/or less/non-lossy format than the video) may be captured at appropriate times (e.g., when the user is pointing the camera at the location with potential damage. It will be understood that most modern user devices have the capability to simultaneously collect video and still images. This example may also be advantageous because it saves storage space on the user device 100 (e.g., high quality still images require less memory than high quality video) and less bandwidth to transmit via the network 205.

In some exemplary embodiments, when the still images and/or videos are transmitted via the network to the server 210 (or other storage location) the images may be deleted from the user device 100 to free memory.

As described above, the one or more machine learning models (e.g., classifiers) of the AI system may be trained based on the views or images that a human would expect to see when assessing the vehicle, e.g., the industry “standard” views. Thus, in some exemplary embodiments, the AI system may direct the user device 100 to collect these standard views without any prompts or input from the user. An example of a standard view may include 4 corner still images of the vehicle typically used by people in the industry. Those skilled in the art will understand that there may be other standard views. As described above, these images may be auto-taken during the image capture 310 operations. In other exemplary embodiments, these images may be extracted from the video.

In some exemplary embodiments, the machine learning model may determine from the collected video that there is the possibility of internal or mechanical damage. In this type of scenario, the user may be prompted to open portions of the vehicle such as the hood, trunk, or doors, to record additional images to allow the AI system to evaluate any damage that may be present. In other exemplary embodiments, the machine learning models may determine from the collected video that there is internal or mechanical damage without prompting the user to record any additional images.

Moving on to the AI evaluation 320 operations, as was described above, the AI system may perform the AI evaluation 320 operations using the images captured in 310. The AI evaluation 320 operations may be performed by one or more machine learning models that are run on the user device 100 and/or the server 210. The one or more machine learning models may assess damage to the vehicle, including, but not limited to, determining whether a part should be repaired or replaced, an estimate of the labor hours for the repair, ordering parts, etc. The one or more machine learning models may enable the application to produce a full or partial initial estimate to repair the damage to the vehicle. Thus, the output of the AI evaluation 320 operations should be the desired results for repairing the vehicle. These operations to output the correct results at this stage of the inspection are outside the scope of the present application. That is, there are a myriad of machine learning models that are trained to output the desired results of the inspection. The focus of the present application is to improve the confidence that the results output by the machine learning models are correct or to initiate a further evaluation when the AI system does not have full confidence in the output results.

Some exemplary manners of improving the output of the AI evaluation 320 were described above in the improvement of the image capture 310. Improved information gathering at the image capture 310 stage will improve the results of the machine learning models operating on the collected information.

In addition, some examples of the AI system having a high or low confidence in the output results have been provided above. When the AI system has a high confidence in the results, the inspection results 350 may be provided to the relevant entity. However, when the AI system does not have a high confidence in the results, further evaluation 340 may be required. The following provides some additional examples of the further evaluation 340. These further examples may be considered to be “gray area” or “edge” cases. These cases may be considered to be more difficult because the AI system does not have a high confidence in the results and the AI system may ask for additional help on these cases from a human expert.

In some exemplary embodiments, the AI system may request that a human expert intervene in the process to aid the AI system with the inspection. For example, the AI system may route the collected images (e.g., video and/or still images) to a video viewer interface of the human expert. This may be, for example, a web based interface that is able to display the images. In some example, the collected video is available to be viewed, and the human expert can move to different points in the video (e.g., images of certain parts of the vehicle) using a scrolling bar or other type of viewing mechanism. The video viewer may also include other types of controls that may be used by the human expert to evaluate damage in the collected images. These other types of controls may include brightness control, color inversion, zoom controls, etc.

Other examples of features that may be included in the video viewer may include an image of generic top down vehicle that may be displayed as an overlay or sidebar on the video viewer. The human expert may select a location on the generic vehicle and the video showing the corresponding location on the vehicle being inspected may be displayed to the human expert. This allows the human expert to move to images moving to video clips from anywhere in 360 circle around the vehicle. In addition, the AI system may place one or more indications of points of interest either in the generic vehicle overlay or as points of interest in the scroll bar. These points of interest may indicate to the human expert, the location of potential damage that the AI system is having difficulty obtaining a high degree of confidence in its evaluation.

As described above, the points of interest are typically based on damaged parts, and may include an indication of the initial inspection result of the AI system, e.g., should a part be repaired/replaced, repair hours, or other information potentially including part prices, replacement labor hours, availability of the part, etc. When the human expert selects the point of interest, video and/or still images of that region including any closeups may be displayed to the human expert. The video viewer may also list the various damaged components in order of severity, cost to repair, etc. In another example, the point of interest may be the estimated/predicted point of impact as determined by the AI system. This area almost always includes damage.

As described above, the AI system may also route the initial inspection results to the video viewer for the human expert to see. In some exemplary embodiments, the AI system may also include a reason for a particular inspection result, e.g., why a particular part received a repair or replace result. Based on the video, the human expert may supplement the initial inspection results based on their expert knowledge to result in final inspection results that are a combination of the analysis performed by the AI system and the human expert. In some exemplary embodiments, the supplements provided by the human expert may be fed back to the AI system for additional training of the one or more machine learning models such that the AI system may have a higher confidence when the AI system sees similar damage profiles in the future.

It should also be understood that these further evaluation 340 operations may be performed at a time later than the image capture 310 operations, e.g., hours or days after the completion of the image capture 310. However, these further evaluation 340 operations may also be performed substantially simultaneously with the image capture 310 operations. For example, the AI system may route the images in real time to the video viewer when the AI system understands that there may be an issue in providing high confidence results. In this manner, the human expert may also provide feedback to the AI system to aid in the image capture 310. Again, this human expert feedback on the image capture may be used to further train the one or more machine learning models of the AI system related to the image capture.

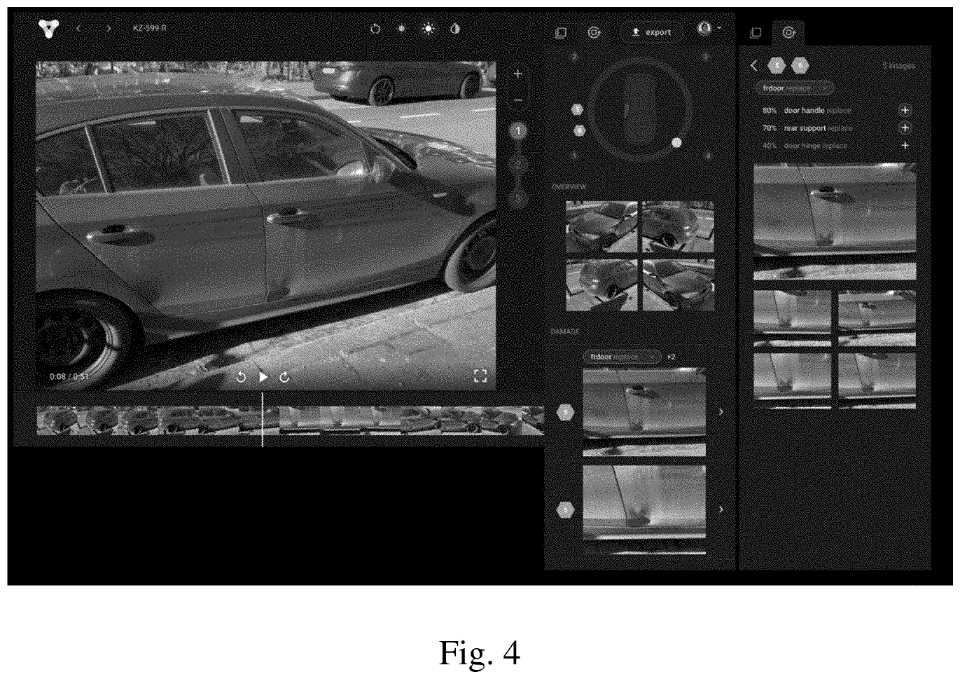

FIG. 4 shows an example view of a video viewer according to various exemplary embodiments. This example view shows some of the exemplary features described above. For example, the left most box of the view may display the video including the scroll bar on the bottom of the video for the user to move to various locations within the video.

In another example, the center top box of the view shows a 360 degree representation of the vehicle. The hexagons with the numbers (5, 6) may identify locations of damage/potential damage for the vehicle. By selecting one or more of these hexagons in the 360 degree view, the video in the left most box may skip to the portion of the video showing the damage/potential damage identified by the hexagon. In another example, by selecting one or more of these hexagons, still images of the damage/potential damage may be displayed by the view. In this example, these still images are shown in the bottom center box of the view. As described above, these still images may be images extracted from the video or may be separate higher quality images that were collected automatically or that the user was directed to collect.

In addition, the center top box also shows diamonds with numbers (1-4). These diamonds may represent the standard 4 corner still images of the vehicle so the human expert may be oriented using the numbers. The actual 4 corner still images may be shown in the center middle box of the view. Again, these images may be images extracted from the video or may be separate higher quality images that were collected automatically or that the user was directed to collect.

The right most box of the view may display the evaluation of the AI system with respect to each of the locations having the identified damage/potential damage. In this example, the display includes an identification of the damaged part, the repair/replace decision and the confidence value assigned by the AI system to the decision. In addition, the images of the damages are also shown in this box.

It should be understood that the view of FIG. 4 is only exemplary and that different implementations of a video viewer may include more, less or different features in a variety of views.

In other exemplary embodiments, the further evaluation 340 operations may or may not include routing of information to a human expert. For example, in some examples, the further evaluation 340 operations may be performed exclusively by the AI system to produce highly confident results. In other examples, the further evaluation 340 operations may be performed by the AI system and the results may be routed to a human expert for confirmation and/or supplements. In still further examples, the further evaluation 340 operations may be performed by the AI system and the results may be routed to multiple human experts for confirmation and/or supplements and to allow the AI system to mediate between the multiple experts.

In some exemplary embodiments, the further evaluation 340 operations may be based on the signature of the damage (e.g., a collection of the point of impact, parts that need repair/replacement, severity of damage, etc.). The AI system may be trained to recognize statistical correlations between the damage signature and other repairs that are likely to occur. That is, the visual inspection of the images may not uncover these other repairs but the AI system has the statistical correlation information that indicates the other repairs are likely for this damage signature. These other repairs may relate to individual parts that are visible but are not individually assessed by the AI system and/or internal/non-visible damage. The likelihood of these various damages not identified by the visual inspection performed by the AI system may be included in the initial (or final) estimate as a percentage chance.

The AI system may also identify the type of body damage, such as large dents, dimples, scratches, cracks, plastic or non-plastic deformations. Additionally, the AI system may identify the material of the damaged part, such as aluminum, stainless steel, plastic, or other materials.

The types of damages identified by this statistical correlation may be body damage, but may also include other types of damage such as mechanical, structural, or other damages. These other damages or repairs may also be categorized. Example categories may include safety related, cosmetic related, etc. In addition to the example information for the signature of the damage described above, other information that may or may not be identified by the AI system may be included in the damage signature for purposes of the statistical correlation. This other information may include whether airbags were deployed, whether visible fluids are leaking from the vehicle, etc. Furthermore, the statistical correlation may use non-visual information in its evaluation. Examples of non-visual information may include a manufacturer's diagram of the vehicle (e.g., to understand where various parts are in the vehicle), part numbers, etc.

It should also be understood that the term statistical correlation may refer to a manner of mathematically determining a likelihood of a result without using AI or machine learning or may include machine learning tools/AI. The training of the machine learning models for such a statistical correlation may include use of visual images and labels of historic internal damages. In this manner, the machine learning model r may predict likelihood of these other repairs (e.g., internal damage).

As described above, this information provided by the further evaluation 340 may be limited to the AI system. For example, if the above example of a statistical correlation indicate that the other repairs are 90% (or some other selected threshold) likely to be needed. The AI system may include these other repairs in the inspection results 350 without the need to involve a human expert. Alternatively, these repairs can be included but flagged for a human expert to verify, or provide an opportunity for a human expert or other system to alter.

In another example, this information provided by the further evaluation 340 that has a confidence level below a selected threshold (or regardless of the confidence level) may be routed to the human expert to look at the identified part that may be damaged and decide whether to add the part/repair to the inspection results.

One of the advantages of this statistical correlation information is that it may identify these other repairs early, e.g., before the vehicle is at the repair shop. This allows the non-visual identified parts that may be damaged to be ordered to reduce the time to repair the vehicle. To provide one specific example of a statistical correlation that may reveal a repair that may not be identified by the visual inspection of the images may include if the front bumper cover and the front fender are both damaged, then it is likely that the impact bar inside the bumper is also damaged and will need repair.

Another advantage is that for estimating and/or First Notice of Loss (FNOL) triage uses, the likely additional damages could be predicted to determine likely additional costs. This may be sufficient to change the status of the vehicle from a clear repairable to a potential total loss, or a potential total loss to a clear total loss, etc.

In another example, during an audit/review of the AI system results by an insurer of the proposed repair plan of a body shop, this statistical information could assist in understanding why an item is included in a repair list even though it was not identified by the visible inspection of the images.

In another example process flow related to the method of FIG. 3, the following scenario involving the various operations may be performed using some of the examples described above. After the image capture 310 operations are complete, the AI evaluation 320 (and/or the further evaluation 340) may determine whether there is any potential internal damage to the vehicle based on the collected images. As described above, the determination of internal damage may be more accurate due to one or more of the collection of better input data at the image capture 310 stage, the statistical correlation operations and the improved machine learning model training based on the improved data input.

If the vehicle is triaged as without internal damage, it may be considered that the AI evaluation is sufficient and the remaining operations can be performed by the AI system without any human input, e.g., the AI evaluation is considered to have a high confidence value because all the damage is surface damage and the AI is confident in its visual evaluation of surface damage.

If the vehicle is triaged as with internal damage, the images and preliminary inspection results may be sent to the human expert (e.g., adjuster) so that the further evaluations 340 may be performed. In some exemplary embodiments, this sending of the information to the human expert may be performed automatically by the AI system. In other exemplary embodiments, the user of the user device 100 may be alerted to the internal damage determination and the user may tap a button or some other UI interface to send the information to the human expert.

Alternatively, the internal images captured may be used to allow the use of machine learning models such as classifiers trained to identify internal damage by visual based information. Additionally, any audio information captured could additionally be analyzed based on audio machine learning models to identify and classify internal damage. Models can be employed against the other information gathered regarding the vehicle and an accident, including statistical models, to determine likely internal damages. In one embodiment, machine learning models, or a combination of machine learning models, could be utilized to evaluate both audio and visual damage and combined with other models, including statistical models, to arrive at predictions of internal damage including mechanical and structural damage, and potential repair operations and repair times.

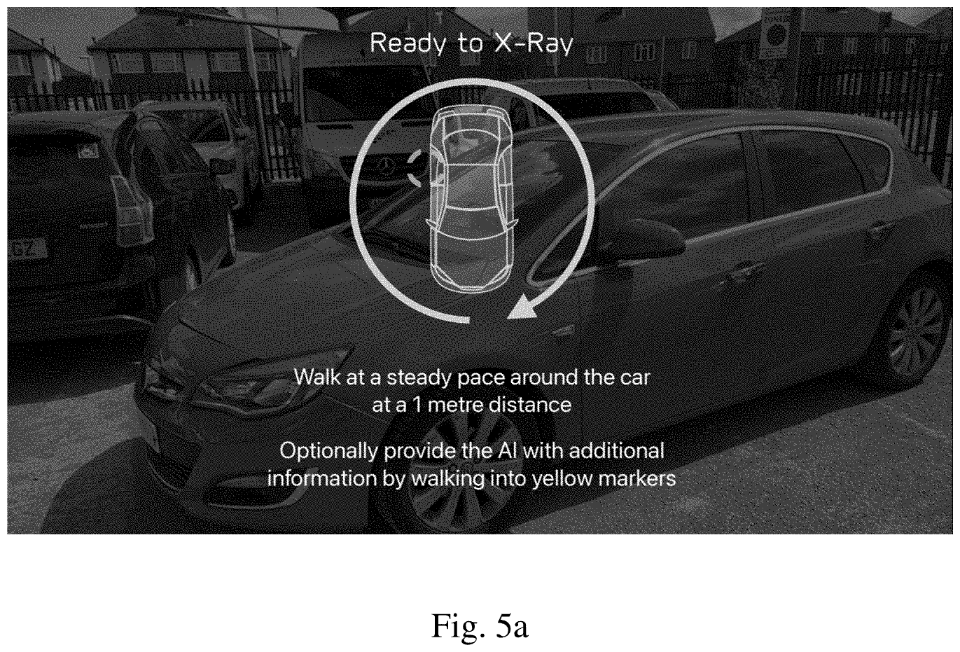

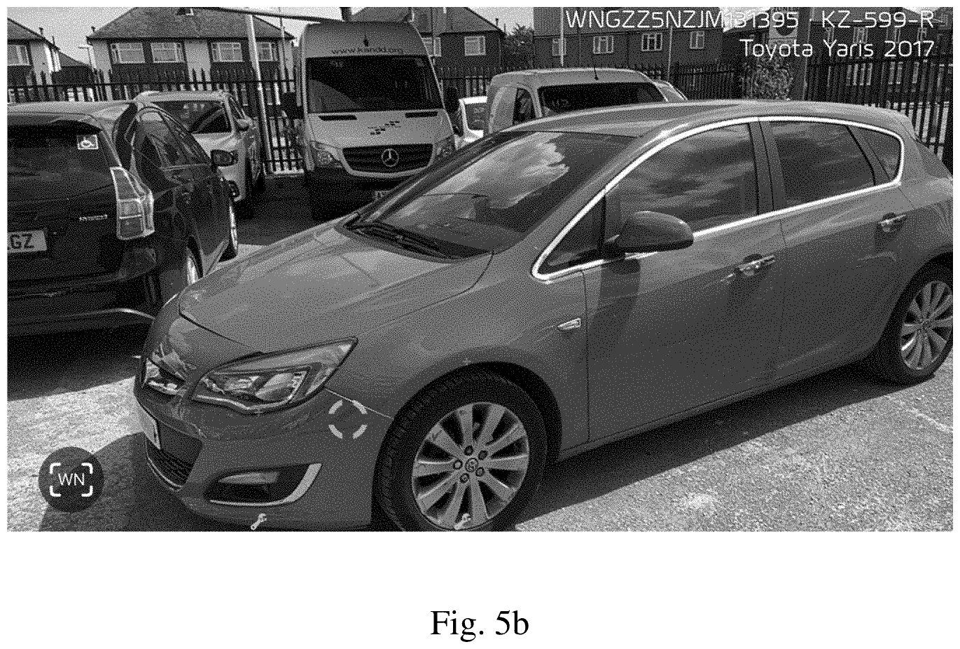

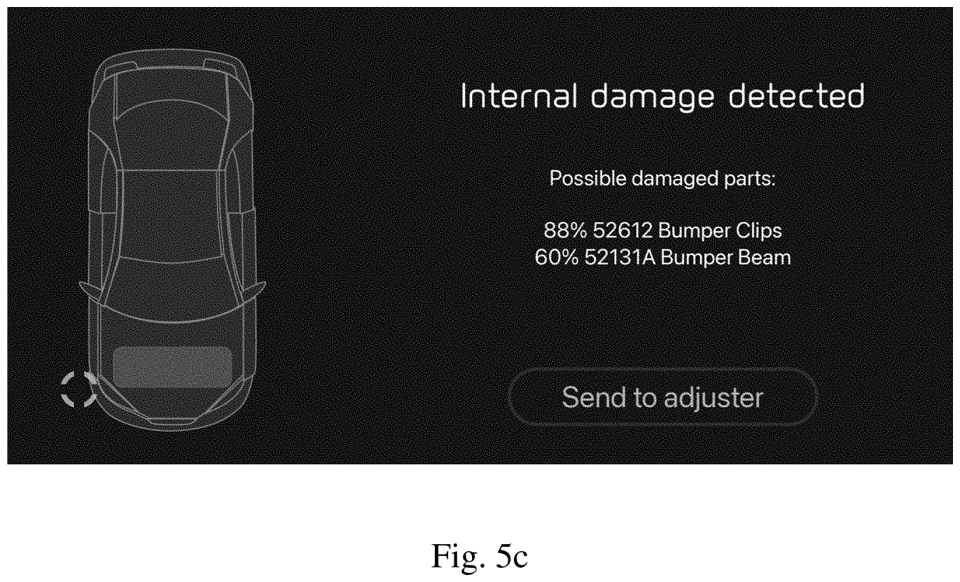

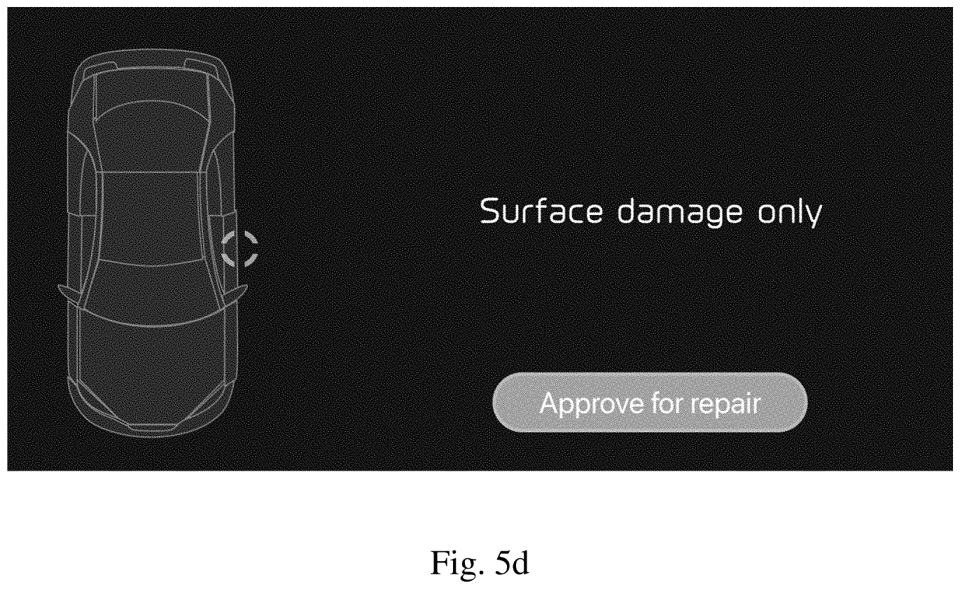

FIGS. 5a-d show example screen shots of an AI application on the user device 100 according to various exemplary embodiments. The screen shots show an example of the above exemplary process flow related to the scenario regarding the possible internal damage for a vehicle.

In FIG. 5a, the user of the user device 100 is instructed as to how to take a video of the vehicle.

In FIG. 5b, the application indicates to the user, via the bullseye prompt that is shown by the front bumper that additional video and/or still images should be taken of the area of interest highlighted by the prompt. Examples of the different actions that a user may be prompted to perform were described above. This screen also shows, in the upper right hand corner, the vehicle identifying information that has been collected, e.g., VIN, license plate and make/model/year of vehicle.

In FIG. 5c, it may be considered that, based on the visual inspection and/or the statistical correlation, the AI system has identified potential internal damage. In this example, the potential internal damage includes bumper clips and a bumper beam. The AI has also assigned a confidence value to the potential damage, e.g., bumper clips 88% and bumper beam 60%. As shown in FIG. 5c, the user of the user device has an option to click a button on the GUI to send the information to a claims adjuster. As described above, the information that is sent to the claims adjuster may include the video, still images, AI system evaluation results, etc.

In FIG. 5d, it may be considered that, based on the visual inspection and/or the statistical correlation, the AI system has identified that there is no potential internal damage, e.g., the vehicle has suffered only surface damage. In this example, the user may accept the AI estimate and approved the repair for the vehicle.

The examples provided above are described with regard to the user recording video of the exterior of the vehicle. Similar processes may be used to guide the user in recording video of other aspects of the vehicle such as, but not limited to, the interior of the vehicle, under the hood of the vehicle (e.g., the engine, etc.), the undercarriage of the vehicle, inside the trunk, etc. For example, the user may be instructed to record video of the interior of the vehicle, as a separate video or a continuous video with the exterior portions, to video specific interior features such as the driver seat, the odometer, the dashboard, the interior roof, the rear seats, etc. In some exemplary embodiments, these instructions may include wire frame images of the item of interest for the user to position into the camera view.

As described above, the exemplary AI system may direct the user or the user device (without user interaction) in various manners to collect images and/or video to improve the vehicle inspection process. The exemplary AI system may be adapted to different use cases by adjusting various parameters based on the selected use case (e.g., an insurance claim use case, an inspection for vehicle purchase use case, etc.) In other examples, the AI system may adjust parameters based on a location (e.g., country, region, state, province, county, city, etc.).

In other examples, the AI system may adjust parameters based on observed conditions, such as lighting, multiple vehicles in the shot, etc. For example, for use cases involving evaluation of cars for consumer purchase, the parameters may be adjusted to optimize for the capture of small cosmetic damage. In this case, where the AI system determines that there appears to be obstructed or distorted views of a part (such as due to glare or reflections), the AI system may ask the user for closer or additional images to be captured. Additionally, based on the lighting situation, the system may modify the image capture parameters of the user device such as digital gains, ISO settings, aperture settings, optical zooms, exposure length, etc.

The AI system on the user device (e.g., user device 100) may also collect data related to vehicle inspections performed by the user device 100 such as keeping track of user compliance rates, whether the capture process is completed, the time to complete the capture process, and if the user does not complete the capture process where the process ended, etc. Additionally, the user device 100 may collect end user feedback on the image capturing process. The user device 100 may report this information to the server 210, where a portion of the AI system that resides on the server 210 can aggregate and analyze the information from multiple end user devices.

For example, the AI system may analyze the quality of the capture process for various use cases, e.g., user compliance rates over many inspections, how many started capture processes were completed, an average time to complete the capture process, how many started capture processes were not completed, where in the process did the average user stop, etc. This can include the results of quality assurance audits, other AI based checks of the results, the ability of the AI systems to produce results with high confidence, or other evaluations. The system could then automatically adjust various parameters to optimize the image capture process with respect to for example image collection completion rates, good user experience ratings, and the quality of the images with respect to performing the intended use case. These parameters adjusted include those described above, including requesting additional images with respect to certain parts, additional angles, moving closer or further, as well as adjustments to the image collection settings on the image capturing device, such as the camera of a mobile device.

While the AI system may automatically implement these adjustments to meet the design optimization desired, it may also suggest these to a human operator for approval. Alternatively, a limited scope of adjustments may be allowed to occur automatically, while a broader scope may occur only with human approval. The AI system that is used for these adjustment tasks itself could be a machine learning system. The adjustments proposed vary for each individual collection event. For example, the AI system may predict based on information regarding the collection event what adjustments to the image collection system would result in a desired optimization of the various elements discussed above. This could include adjustments based on the time of day, the region, local weather conditions at the time of the collection, and the use case. If, for example, there is current or forecasted severe weather, the AI system could be adjusted to speed up the collection process to protect the well-being of the user. In addition, these adjustments may be based on information obtained prior to or during the image collection process (including information determined by machine learning models based on prior images during the process). For example, in a first notice of loss damage type situations, the AI system may determine that there is damage consistent with a total loss. The AI system may adjust the parameters to ensure that the collected images include the information necessary to confirm that determination. In another example, if, during an inspection use case, the AI system detects minor damage such as a long scratch on one panel, the AI system may adjust the parameters to ensure more images of neighboring panels that may also have been damaged.

Those skilled in the art will understand that the above-described exemplary embodiments may be implemented in any suitable software or hardware configuration or combination thereof. An exemplary hardware platform for implementing the exemplary embodiments may include, for example, an Intel based platform with compatible operating system, a Windows OS, a Mac platform and MAC OS, a mobile device having an operating system such as iOS, Android, etc. The exemplary embodiments of the above-described methods may be embodied as software containing lines of code stored on a non-transitory computer readable storage medium that, when compiled, may be executed on a processor or microprocessor.

Although this application described various embodiments each having different features in various combinations, those skilled in the art will understand that any of the features of one embodiment may be combined with the features of the other embodiments in any manner not specifically disclaimed or which is not functionally or logically inconsistent with the operation of the device or the stated functions of the disclosed embodiments.

It is well understood that the use of personally identifiable information should follow privacy policies and practices that are generally recognized as meeting or exceeding industry or governmental requirements for maintaining the privacy of users. In particular, personally identifiable information data should be managed and handled so as to minimize risks of unintentional or unauthorized access or use, and the nature of authorized use should be clearly indicated to users.

It will be apparent to those skilled in the art that various modifications may be made in the present disclosure, without departing from the spirit or the scope of the disclosure. Thus, it is intended that the present disclosure cover modifications and variations of this disclosure provided they come within the scope of the appended claims and their equivalent.

What is claimed:

1. A method, comprising:
capturing images of a vehicle;
performing, by one or more machine learning models, a visual inspection of the vehicle based on the images;
determining, by the one or more machine learning models, inspection results based on the visual inspection; and
determining, by the one or more machine learning models, a confidence value for the inspection results.

2. The method of claim 1, further comprising:
when the confidence value exceeds a predetermined threshold, outputting the inspection results.

3. The method of claim 1, further comprising:
when the confidence value is less than a predetermined threshold, performing at least one additional evaluation of the vehicle.

4. The method of claim 3, wherein the at least one additional evaluation comprises routing the inspection results to a user interface of an expert user.

5. The method of claim 3, wherein the at least one further evaluation comprises a statistical correlation for damaged parts of the vehicle, wherein the statistical correlation is not based on the images.

6. The method of claim 1, further comprising:
displaying representations of damage or potential damage of the vehicle keyed to the images.

7. The method of claim 1, further comprising:
displaying the inspection results determined by the one or more machine learning models, wherein the inspection results include an identification of a damaged part, a repair or replace determination for the damaged part and a confidence value for the inspection results related to the damaged part.

8. The method of claim 1, wherein the capturing the images of the vehicle comprises:
receiving, from one or more machine learning models, instructions for capturing the images.

9. A method, comprising:
initiating an image capture process for capturing images of a vehicle;
determining information related to the image capture process;
selecting one or more parameters for the image capture process based on the information; and
capturing the images based on the selected one or more parameters.

10. The method of claim 9, wherein the information comprises a use case for the image capture process.

11. The method of claim 9, wherein the information comprises a location where the image capture process is being performed.

12. The method of claim 9, further comprising:
determining the information from one or more of the images; and
updating at least one of the selected one or more parameters based on the information determined from the one or more images.

13. The method of claim 9, wherein the selected one or more parameters comprise a setting of a device performing the image capture process, wherein the setting comprises one of a digital gain, an ISO setting, an aperture setting, an optical zoom, or an exposure length.

14. The method of claim 9, wherein the selected one or more parameters comprise an instruction to a user of a device performing the image capture process.

15. A method, comprising:
collecting information related to an image capture process for capturing images of a vehicle, wherein the information is collected for multiple performances of the image capture process;
analyzing the information using one or more machine learning models to determine a quality of the image capture process; and
modifying one or more parameters of the image capture process based on the quality of the image capture process.

16. The method of claim 15, wherein the information comprises one of user compliance rates with instructions provided during the image capture process, a completion rate for the image capture process, an average time to complete the image capture process, a percentage completion for image capture processes that were not completed, or user feedback on the image capture process.

17. The method of claim 15, wherein the information comprises results of quality assurance audits for one or more of the multiple performances of the image capture process, artificial intelligence (AI) based checks of results of one or more of the multiple performances of the image capture process, or a confidence level in the results of one or more of the multiple performances of the image capture process.

18. The method of claim 15, wherein the information is associated with a use case for the image capture process and wherein the one or more parameters are modified for only the use case.

19. The method of claim 15, wherein the one or more parameters comprise a setting of a device performing the image capture process.

20. The method of claim 15, wherein the one or more parameters comprise an instruction to a user of a device performing the image capture process.
